(19) United States
(12) Patent Application Publication
(10) Pub. No.: US 2010/0097351 A1
(43) Pub. Date: Apr. 22, 2010

(54) APPARATUS AND METHOD FOR ADJUSTING FINGER DEPTH USING CAMERA AND TOUCH SCREEN HAVING THE APPARATUS

(75) Inventor: Don Won LEE, Seoul (KR)

Correspondence Address: Jae Y. Park, Kile, Goekjian, Reed & McManus, PLLC, 1200 New Hampshire Ave. NW, Suite 570, Washington, DC, 20036, US

(73) Assignee: COMBUSTEC CO., LTD, Seoul (KR)

(21) Appl. No.: 12/576,325

(22) Filed: Oct. 9, 2009

(30) Foreign Application Priority Data
Oct. 21, 2008 (KR) 10-2008-0103160

(51) Int. Cl. G06F 3/042

(52) U.S. Cl. 345/175

(57) ABSTRACT

Disclosed are an apparatus and a method for adjusting a finger depth using a camera and a touch screen having the apparatus. The apparatus includes a light source installed at an edge of a panel to radiate light in parallel to a surface of the panel, a camera that photographs an object and light emitting points of the light source, and a control circuit that establishes a reference line having a predetermined finger depth by joining the light emitting points and limit lines having various finger depths which are remote from the reference line by several pixels corresponding to resolution of the camera. The control circuit determines whether the object approaches the reference line or the limit lines and determines a position of the object to output a display control signal. The apparatus allows a user to select a desired finger depth.

### BACKGROUND OF THE INVENTION

1. Field of the Invention

The present invention relates to an optical type touch screen. More particularly, the present invention relates to an apparatus and a method for adjusting a finger depth using a camera and a touch screen having the apparatus, in which various finger depths are set based on photographing information of the camera such that a user can select a desired finger depth.

2. Description of the Related Art

Conventional touch screens are mainly classified into resistance, capacitance, surface acoustic wave (SAW), infrared (IR), and optical type touch screens according to input schemes thereof. These input schemes have their own features and advantages/disadvantages.

Among them, the optical type touch screen processes the user's input by combining a camera, a digital signal processing, front or rear illumination, and algorithm used for determining a touch time. The camera photographs an image of an object, such as a finger or a stylus, by scanning a display surface. Since the optical type touch screen performs the image processing based on the shadow and movement of bright light, it may cause the reading error and the touch screen must be touched by the object prior to reading the data. Various attempts have been performed to overcome the above problems, and such attempts may closely relate to the finger depth.

FIG. 1 is a view showing the concept of the finger depth.

As shown in FIG. 1, the finger depth FD signifies the distance between a touch screen (panel) and a tip of an object P, such as a finger, when the object P approaches the touch screen to touch the touch screen. The finger depth FD can be variously set according to the size, applications and usage environment of the touch screen.

That is, the finger depth FD must be set based on the size, applications and usage environment of the touch screen, and the finger depth FD is fixed as it is set. Thus, the camera must be reset in order to reset the finger depth FD, causing inconvenience of the user.

Until now, there are no methods for variably adjusting the finger depth FD. In addition, there are no apparatuses for adjusting the finger depth FD using software.

### SUMMARY OF THE INVENTION

Accordingly, the present invention has been made keeping in mind the above problems occurring in the prior art, and an object of the present invention is to provide an apparatus and a method for adjusting a finger depth using a camera and a touch screen having the apparatus, in which a plurality of limit lines having various finger depths are defined on predetermined positions remote from a reference line having a finger depth that is set in the initial setting, thereby enabling a user to select a desired finger depth.

To accomplish the object, according to one aspect of the present invention, there is provided an apparatus for adjusting a finger depth, the apparatus including: a light source installed at an edge of a panel to radiate light in parallel to a surface of the panel; a camera that photographs an object and light emitting points of the light source; and a control circuit that establishes a reference line having a predetermined finger depth by joining the light emitting points and limit lines having various finger depths which are remote from the reference line by several pixels corresponding to resolution of the camera, wherein the control circuit determines whether the object approaches the reference line or the limit lines and determines a position of the object to output a display control signal.

According to another aspect of the present invention, there is provided a method for adjusting a finger depth using a camera, the method including: radiating light in parallel to a surface of a panel; photographing light emitting points using the camera; establishing a reference line having a predetermined finger depth by joining the light emitting points; establishing limit lines having various finger depths which are remote from the reference line by several pixels corresponding to resolution of the camera; and determining whether an object approaches the reference line or the limit lines by receiving an image of the object from the camera and determining a position of the object to output a display control signal.

According to another aspect of the present invention, there is provided a touch screen including: a panel; a light source installed at an edge of the panel to radiate light in parallel to a surface of the panel; a camera that photographs an object and light emitting points of the light source; a control circuit that establishes a reference line having a predetermined finger depth by joining the light emitting points and limit lines having various finger depths which are remote from the reference line by several pixels corresponding to resolution of the camera, in which the control circuit determines whether the object approaches the reference line or the limit lines and determines a position of the object to output a display control signal; and a display for displaying or expressing a result executed according to the display control signal, in which the panel is arranged on a front surface of the display.

As described above, according to the apparatus and the method for adjusting the finger depth using the camera and the touch screen having the apparatus, the user can select the limit line having the desired finger depth from among the limit lines having various finger depths, so that the finger depth suitable for the size, applications and usage environment of the touch screen can be selected.

In addition, the present invention can be utilized to control the three-dimensional object expressed with two-dimension by assigning various functions to several limit lines selected from the plural limit lines.

Further, even if the position of the camera is changed due to external influence, the reference line having the finger depth can be reset and the limit lines having various finger depths can be set based on the reference line, so that it is not necessary to reset the camera.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing the concept of a finger depth;

FIG. 2 is a view showing a structure of a touch screen having an apparatus for adjusting a finger depth using a camera according to one embodiment of the present invention;

FIG. 3 is a view showing the concept for detecting the position of an object according to one embodiment of the present invention;

FIG. 4 is a view showing the concept for obtaining the position of an infrared LED and a reference line on a camera screen according to one embodiment of the present invention;

FIG. 5 is a view showing the concept for adjusting the finger depth according to one embodiment of the present invention;

FIG. 6 is a block view showing a control circuit of the apparatus for adjusting a finger depth using a camera according to one embodiment of the present invention; and

FIG. 7 is a flowchart showing the method for adjusting a finger depth using a camera according to one embodiment of the present invention.

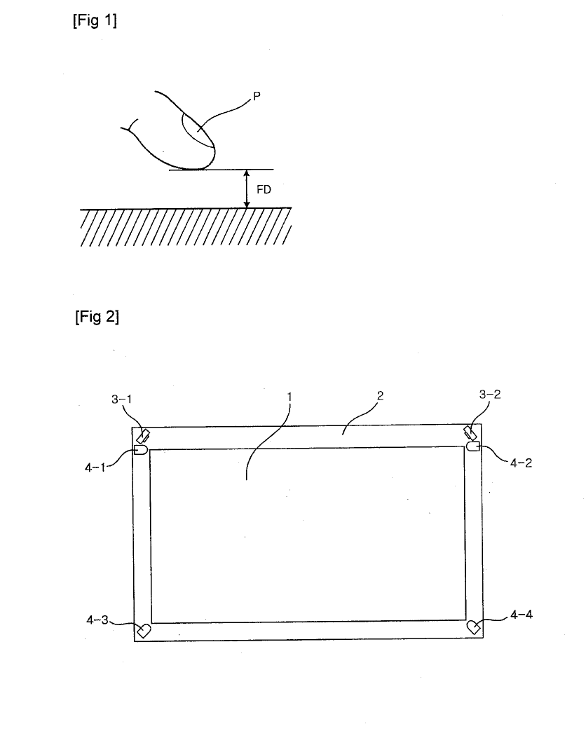

### DETAILED DESCRIPTION OF THE INVENTION

Hereinafter, an apparatus and a method for adjusting a finger depth using a camera and a touch screen having the apparatus according to preferred embodiments of the present invention will be described in detail with reference to accompanying drawings.

FIG. 2 is a view showing the structure of the touch screen having the apparatus for adjusting the finger depth using the camera according to one embodiment of the present invention.

As shown in FIG. 2, the touch screen according to the present invention includes a display 1, a panel 2 formed on a front surface of the display 1, two cameras 3-1 and 3-2 arranged at upper left and right edges of the panel 2, and four infrared LEDs 4-1, 4-2, 4-3 and 4-4 arranged at four edges of the panel 2, respectively. Although two cameras 3-1 and 3-2 and four infrared LEDs 4-1, 4-2, 4-3 and 4-4 are adopted in this embodiment, the present invention is not limited thereto.

The cameras 3-1 and 3-2 include CMOS cameras or CCD cameras having M×N pixels, in which M denotes 1024 pixels or more and N denotes 50 pixels or more.

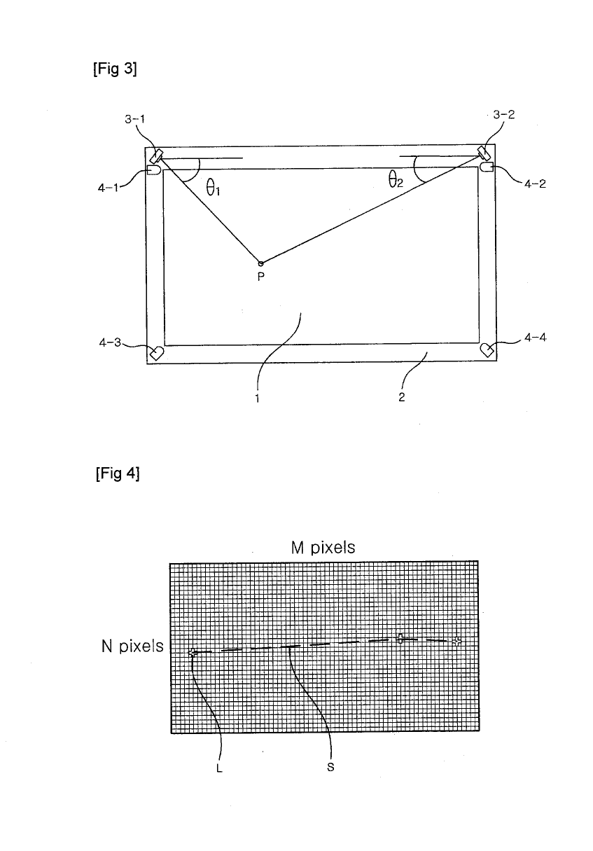

FIG. 3 is a view showing the concept for detecting the position of an object according to one embodiment of the present invention.

As shown in FIG. 3, a basic coordinate of an object P, such as a finger, can be obtained by converting the position of the object P detected from two cameras 3-1 and 3-2 into information of radiation angles θ₁ and θ₂ of the two cameras 3-1 and 3-2.

That is, the position of the object P corresponds to the coordinate where the radiation angles θ₁ and θ₂ of the two cameras 3-1 and 3-2 cross each other.

FIG. 4 is a view showing the concept for obtaining the position of an infrared LED and a reference line on a camera screen according to one embodiment of the present invention.

As shown in FIG. 4, in order to establish the reference line S, three of four infrared LEDs, except for the infrared LED installed corresponding to the camera, radiate light such that the camera can photograph the image. For instance, when the reference line S is established by using the camera 3-2, the infrared LED 4-2 is turned off and the remaining infrared LEDs 4-1, 4-3, and 4-4 are turned on, so that three light emitting points L positioned corresponding to the infrared LEDs 4-1, 4-3, and 4-4 are photographed. The three light emitting points L correspond to the positions of the infrared LEDs 4-1, 4-3, and 4-4.

Then, the reference line S is established by joining the three light emitting points L. This can be obtained at a time when the cameras are attached to the panel under the condition that the position of the cameras is not changed. In addition, the process for establishing the reference line S can be repeated for variation of the cameras caused by external influence, application of system power and demand of users.

Meanwhile, the reason for using the infrared LEDs is that the infrared LEDs may not dazzle eyes of a person and the cameras can photograph the object in the brighter area.

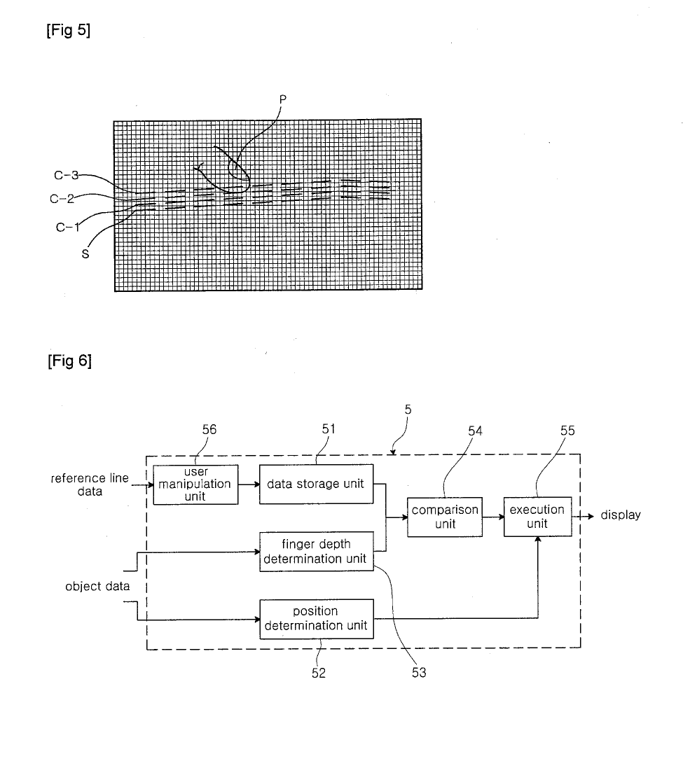

FIG. 5 is a view showing the concept for adjusting the finger depth according to one embodiment of the present invention.

As shown in FIG. 5, if the reference line S has been established, a first limit line C-1 is further established at a position remote upward from the reference line S by several pixels in the direction of N pixels. If necessary, a second limit line C-2, a third limit line C-3, . . . , and an N^{th} limit line (N is a natural number) can be further established at positions remote upward from the first limit line C-1 or the reference line S by several pixels.

Accordingly, the reference line S and the limit lines C-1, C-2 and C-3 having various finger depths can be established so that the user can select the desired finger depth based on the reference line S and the limit lines C-1, C-2 and C-3. At this time, the interval between the reference line S and the limit lines C-1, C-2 and C-3 can be predetermined. Further, the interval among the limit lines C-1, C-2 and C-3 can also be predetermined.

Meanwhile, it is also possible to control the display output by assigning various functions to the reference line S or several limit lines selected from the limit lines C-1, C-2 and C-3. For instance, the present invention can be utilized to select the three-dimensional object expressed with two-dimension provided in the window vista operating system. That is, the three-dimensional object expressed in the front surface can be selected based on the third limit line C-3 that is away from the reference line S and the three-dimensional object expressed in the rear surface can be selected based on reference line S or the first limit line C-1 that is closed to the reference line S.

FIG. 6 is a block view showing a control circuit of the apparatus for adjusting the finger depth using the camera according to one embodiment of the present invention.

As shown in FIG. 6, the control circuit 5 of the apparatus for adjusting the finger depth using the camera according to one embodiment of the present invention includes a data storage unit 51 for storing data about the reference line and limit lines, which are initially set or preset by the user, a position determination unit 52 for determining the position of the object on the display, a finger depth determination unit 53 for determining the finger depth of the object on the panel, a comparison unit 54 for comparing the finger depth determined by the finger depth determination unit 53 with predetermined finger depths of the reference line and the limit lines stored in the data storage unit 51, and an execution unit 55 for executing data required in the position of the object determined by the position determination unit 52 when the object reaches the predetermined finger depth. Preferably, a user manipulation unit 56 is further provided in order to allow the user to set the limit lines. The data executed by the execution unit 55 is displayed on the display.

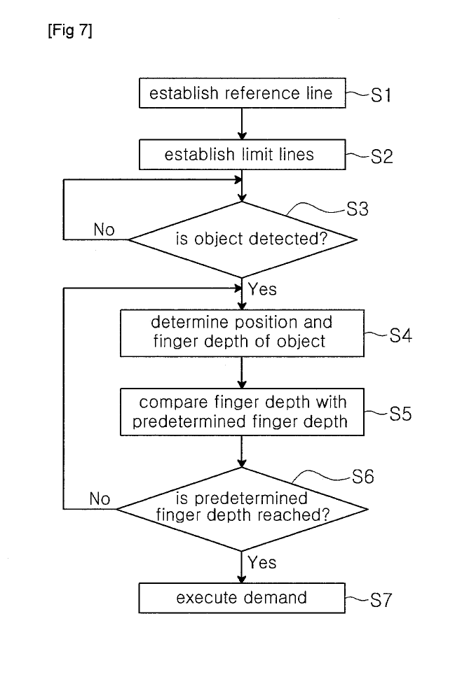

Hereinafter, the method for adjusting the finger depth using the camera, which is applicable for the apparatus for adjusting the finger depth using the camera and the touch screen having the apparatus, will be described with reference to FIG. 7.

FIG. 7 is a flowchart showing the method for adjusting the finger depth using the camera according to one embodiment of the present invention.

As shown in FIG. 7, three light emitting points are photographed by radiating light using three of four infrared LEDs, except for the infrared LED installed corresponding to the camera, and the reference line S is established by joining the three light emitting points (S1).

As the reference line S has been established, a plurality of limit lines are further established on positions remote upward from the reference line S by several pixels in the direction of the N pixels (S2). The limit lines can be preset or can be set by the user.

After the initial setting for the reference line S and the limit lines has been completed, if the object, such as the finger or stylus, approaches the panel, the finger depth corresponding to the position of the object on the display photographed by the camera is determined (S3). Then, the determined finger depth is compared with the finger depth of the reference line or the limit line, thereby checking the position and the finger depth of the object (S4 to S6).

If the object is positioned on the limit line having the finger depth preset by the user, the image processing or the demand of the user is executed and the result is displayed on the display (S7).

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for adjusting a finger depth, the apparatus comprising:
a light source installed at an edge of a panel to radiate light in parallel to a surface of the panel;
a camera that photographs an object and light emitting points of the light source; and
a control circuit that establishes a reference line having a predetermined finger depth by joining the light emitting points and limit lines having various finger depths which are remote from the reference line by several pixels corresponding to resolution of the camera, wherein the control circuit determines whether the object approaches the reference line or the limit lines and determines a position of the object to output a display control signal.

2. The apparatus of claim 1, wherein the control circuit includes:
a data storage unit for storing data about the reference line and limit lines, which are initially set or preset by a user;
a position determination unit for determining the position of the object on the display;
a finger depth determination unit for determining the finger depth of the object on the panel;
a comparison unit for comparing the finger depth determined by the finger depth determination unit with predetermined finger depths of the reference line and the limit lines stored in the data storage unit; and
an execution unit for executing data required in the position of the object determined by the position determination unit when the object reaches the predetermined finger depth.

3. The apparatus of claim 2, further comprising a user manipulation unit to allow the user to set the limit lines.

4. The apparatus of claim 1, wherein the light source includes an infrared LED.

5. A method for adjusting a finger depth using a camera, the method comprising:
radiating light in parallel to a surface of a panel;
photographing light emitting points using the camera;
establishing a reference line having a predetermined finger depth by joining the light emitting points;
establishing limit lines having various finger depths which are remote from the reference line by several pixels corresponding to resolution of the camera; and
determining whether an object approaches the reference line or the limit lines by receiving an image of the object from the camera and determining a position of the object to output a display control signal.

6. The apparatus of claim 5, wherein the position of the object is obtained from a coordinate where radiation angles of two cameras having a common reference line cross each other.

7. The apparatus of claim 5, wherein a plurality of limit lines are set.

8. The apparatus of claim 7, wherein the reference line or the limit lines match with a three-dimensional object expressed with two-dimension.

9. A touch screen comprising:
a panel;
a light source installed at an edge of the panel to radiate light in parallel to a surface of the panel;
a camera that photographs an object and light emitting points of the light source;
a control circuit that establishes a reference line having a predetermined finger depth by joining the light emitting points and limit lines having various finger depths which are remote from the reference line by several pixels corresponding to resolution of the camera, in which the control circuit determines whether the object approaches the reference line or the limit lines and determines a position of the object to output a display control signal; and
a display for displaying or expressing a result executed according to the display control signal, in which the panel is arranged on a front surface of the display.
